(19) United States
(12) Patent Application Publication
(10) Pub. No.: US 2025/0151035 A1
(43) Pub. Date: May 8, 2025

(54) INDICATION OF SELECTION OF SEGMENT DURATION

(71) Applicant: Nokia Technologies Oy, Espoo (FI)

(72) Inventors: Mads LAURIDSEN, Aalborg (DK); Jing Yuan SUN, Beijing (CN); Frank FREDERIKSEN, Aalborg (DK); Tzu-Chung HSIEH, Naperville, IL (US); Jeroen WIGARD, Aalborg (DK); Gilsoo LEE, Naperville, IL (US)

(21) Appl. No.: 18/837,456

(22) PCT Filed: Feb. 14, 2022
(86) PCT No.: PCT/CN2022/076258

§ 371 Date: Aug. 9, 2024

(51) Int. Cl. H04W 72/0446

(52) U.S. Cl. CPC H04W 72/0446

(57) ABSTRACT

Example embodiments of the present disclosure relate to devices, methods, apparatuses and computer readable storage media for beam information reporting. In example embodiments, a first device receives from a second device a configuration of a plurality of segment durations for transmission from the first device to the second device. Further, the first device determines a segment duration of the plurality of segment durations. Moreover, the second device determines a transmission scheme based on the determined segment duration.

### FIELD

Example embodiments of the present disclosure generally relate to the field of communications, and in particular, to devices, methods, apparatuses and computer readable storage media for an indication of a selection of a segment duration.

### BACKGROUND

Fifth generation (5G) new radio (NR) is supported for non-terrestrial networks (NTN). One of the main NTN scenarios involves low-earth orbit satellites, which move with speeds of about 7.5 km/s relative to the earth at altitudes of 600 km. Such fast movement results in fast changing timing advance and frequency shift. Therefore, there is a need for a user equipment (UE) to pre-compensate uplink transmission in the time domain and frequency domain by utilizing knowledge of a location of the UE and a location of the satellite.

Further, repetitions are used to improve link budgets. However, the UE is not allowed to change the timing advance during a repetition, but only at the initial transmission. If a large number of repetitions are used, this would result in significant interference in the uplink transmission.

Therefore, the UE may divide repetitions into segments to overcome the above issue. At each segment, the UE can adjust the transmission in the time domain and frequency domain to ensure that the transmission is well aligned with the time-frequency resource format. However, among others open issues, how to indicate efficiently the selection of a segment duration by the UE to a network device is still an open issue to be addressed.

### SUMMARY

In general, example embodiments of the present disclosure provide methods, devices, apparatuses and computer readable storage media for an indication of a selection of a segment duration.

In a first aspect, a method is provided. In the method, a first device receives, from a second device, a configuration of a plurality of segment durations for transmission from the first device to the second device. Further, the first device determines a segment duration of the plurality of segment durations. Moreover, the first device determines a transmission scheme based on the determined segment duration.

In a second aspect, a method is provided. In the method, a second device sends, to a first device, a configuration of a plurality of segment durations for transmission from the first device to the second device. Further, the second device determines a transmission scheme used by the first device for the transmission. Moreover, the second device determines a segment duration for the transmission based on the transmission scheme, wherein the segment duration is one of the plurality of segment durations.

In a third aspect, a first device is provided which comprises at least one processor and at least one memory including computer program code. The at least one memory and the computer program code are configured to, with the at least one processor, cause the first device to receive, from a second device, a configuration of a plurality of segment durations for transmission from the first device to the second device. Further, the first device is caused to determine a segment duration of the plurality of segment durations. Moreover, the first device is caused to determine a transmission scheme based on the determined segment duration.

In a fourth aspect, a second device is provided which comprises at least one processor and at least one memory including computer program code. The at least one memory and the computer program code are configured to, with the at least one processor, cause the second device to send, to a first device, a configuration of a plurality of segment durations for transmission from the first device to the second device. Further, the second device is caused to determine a transmission scheme used by the first device for the transmission. Moreover, the second device is caused to determine a segment duration for the transmission based on the transmission scheme, wherein the segment duration is one of the plurality of segment durations.

In a fifth aspect, there is provided an apparatus comprising means for performing the method according to the first or second aspect.

In a sixth aspect, there is provided a computer readable storage medium comprising program instructions stored thereon. The instructions, when executed by a processor of a device, cause the device to perform the method according to the first or second aspect.

It is to be understood that the summary section is not intended to identify key or essential features of example embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a signaling flow between the first device and the second device according to some example embodiments of the present disclosure;

FIG. 3 illustrates an example process at the first device according to some example embodiments of the present disclosure;

FIG. 4 illustrates a flowchart of an example method according to some example embodiments of the present disclosure;

FIG. 5 illustrates a flowchart of an example method according to some other example embodiments of the present disclosure; and

FIG. 6 illustrates a simplified block diagram of a device that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these example embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “network device” refers to a device via which services can be provided to a terminal device in a communication network. As an example, the network device may comprise a base station. As another example, the network device may comprise a communicating device on the satellite. As used herein, the term “base station” (BS) refers to a network device via which services can be provided to a terminal device in a communication network. The base station may comprise any suitable device via which a terminal device or UE can access the communication network. Examples of the base stations include a relay, an access point (AP), a transmission point (TRP), a node B (NodeB or NB), an evolved NodeB (eNodeB or eNB), a New Radio (NR) NodeB (gNB), a Remote Radio Module (RRU), a radio header (RH), a remote radio head (RRH), a low power node such as a femto, a pico, and the like.

As used herein, the term “terminal device” or “user equipment” (UE) refers to any terminal device capable of wireless communications with each other or with the base station. The communications may involve transmitting and/or receiving wireless signals using electromagnetic signals, radio waves, infrared signals, and/or other types of signals suitable for conveying information over air. In some example embodiments, the UE may be configured to transmit and/or receive information without direct human interaction. For example, the UE may transmit information to the base station on predetermined schedules, when triggered by an internal or external event, or in response to requests from the network side.

Examples of the user device include, but are not limited to, smart phones, wireless-enabled tablet computers, laptop-embedded equipment (LEE), laptop-mounted equipment (LME), wireless customer-premises equipment (CPE), sensors, metering devices, personal wearables such as watches, and/or vehicles that are capable of communication. For the purpose of discussion, some example embodiments will be described with reference to UEs as examples of the terminal devices, and the terms “terminal device” and “user equipment” (UE) may be used interchangeably in the context of the present disclosure.

As used herein, the term “circuitry” may refer to one or more or all of the following:
(a) hardware-only circuit implementations (such as implementations in only analog and/or digital circuitry) and
(b) combinations of hardware circuits and software, such as (as applicable): (i) a combination of analog and/or digital hardware circuit(s) with software/firmware and (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in a server, a cellular base station, or other computing or base station.

As used herein, the singular forms “a”, “an”, and “the” are intended to include the plural forms as well, unless the context clearly indicates otherwise. The term “includes” and its variants are to be read as open terms that mean “includes, but is not limited to”. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

As used herein, the terms “first”, “second” and the like may be used herein to describe various elements, these elements should not be limited by these terms. These terms are only used to distinguish one element from another. For example, a first element could be referred to as a second element, and similarly, a second element could be termed a first element, without departing from the scope of example embodiments. As used herein, the term “and/or” includes any and all combinations of one or more of the listed terms.

In the third generation partnership project (3GPP) Release 17 (Rel-17), there are some discussions about narrowband internet of things (NB-IoT)/enhanced machine type communication (eMTC) support for NTN. There are also some discussions about 5G NR support for NTN.

As discussed above, to overcome fast changing timing advance and frequency shift caused by the fast movement of the satellites, there is a need for a user equipment (UE) to pre-compensate uplink transmission in the time domain and frequency domain by utilizing knowledge of a location of the UE and a location of the satellite. Then, the IoT radio technologies rely on repetitions to improve the link budgets.

There are 3 preamble formats for NB-IoT (FDD), where each repetition consists of P*(TCP+TSEQ).

| | | | | | Max. | Max. |
|---|---|---|---|---|---|---|
| Preamble | | | | Duration of one | continuous | continuous |
| format | P | T_{CP} | T_{SEQ} | repetition unit | repetitions | Tx time |
| 0 | 4 | 2048 · Ts | 5*8192 · Ts | 5.6 ms | 64 | 358.4 ms |
| 1 | 4 | 8192 · Ts | 5*8192 · Ts | 6.4 ms | 64 | 409.6 ms |
| 2 | 6 | 24576 · Ts | 3* 24576Tₛ | 19.2 ms | 16 | 307.2 ms |

For example, 3GPP technical specification (TS) 36.211 allows NB-IoT preamble repetition unit to reach a maximum of 64 or 16 times before a gap of 40 ms used for re-synchronization, resulting in a maximum continuous transmission time between 307.2 ms and 409.6 ms. Within this transmission time, the TA drift caused by the satellite movement in NTN may lead to timing error in the preamble exceeding some requirements for example, as specified in TS 36.133.

However, the UE is not allowed to change the timing advance during a repetition, but only at the initial transmission. If a large number of repetitions are used, this would result in a significant time drift and thus interference in the uplink transmission.

Therefore, the UE may divide repetitions into segments to overcome the above issue. At each segment, the UE can adjust the transmission in the time domain and frequency domain to ensure that the transmission is well aligned with the time-frequency resource format. For example, a number of segment sizes no larger than the maximum continuous repetitions (such as 2, 4, 8, 16, 64) are agreed to be introduced to support NTN. Some segment related agreements are discussed below.

It is agreed that the UE may perform pre-compensation per segment of NPUSCH for NB-IoT and physical uplink share channeled (PUSCH)/physical uplink control channel (PUCCH) for eMTC from one segment to the next segment by dropping or inserting samples or puncturing orthogonal frequency division multiplexing (OFDM) symbols. Alternatively, the UE may perform the pre-compensation per segment by blanking subframes or slots where the UE skips a slot or a subframe. The method used for the UE to perform pre-compensation is known to the eNB by a single UE capability. Likewise, it is agreed that for NB-IoT, the UE pre-compensation per segment of NPRACH is applied from one segment to the next segment by using the above methods. It is also agreed that for eMTC, the UE pre-compensation per segment of PRACH is applied from one segment to the next segment by dropping or inserting samples in the guard period of the PRACH preamble.

Further, it is also agreed that for NB-IoT NTN, the network device configures one of K values for the UL transmission segment duration of each PRACH preamble format in a k-bit field, where the size of the k-bit field and the number of K candidate values depend on the preamble format. For example, for format 0 and format 1, 3-bit field and 6 candidate values are used, where the 5 candidate values are 2.4. (TCP+TSEQ), 4.4. (TCP+TSEQ), 8.4. (TCP+TSEQ), 16.4. (TCP+TSEQ), 32.4. (TCP+TSEQ), 64.4. (TCP+TSEQ). For example, for format 2, 3-bit field and 5 candidate values are used, where the 5 candidate values are 1.6. (TCP+TSEQ), 2.6. (TCP+TSEQ), 4.6. (TCP+TSEQ), 8.6. (TCP+TSEQ), 16.6. (TCP+TSEQ).

However, currently, it is not supported for the network device to determine which segment duration the UE is using if more than one segment duration is configured. Besides, by now, there is no effective way for the UE to indicate efficiently the selection of a segment duration to a network device.

Example embodiments of the present disclosure provide a scheme for an indication of a selection of a segment duration. With the scheme, a device (referred to as a first device) receives, from another device (referred to as a second device) a configuration of a plurality of segment durations for transmission from the first device to the second device. Further, the first device determines a segment duration of the plurality of segment durations. Moreover, the first device determines a transmission scheme based on the determined segment duration. For example, the transmission scheme may be associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment

This scheme facilitates flexible and efficient determination of the segment duration used by the first device based on the use of different transmission schemes. In this way, implicit indication of the first device's selection of the segment duration enables the second device to configure more than one segment duration. This reduces the overall complexity for the first device, because it can select an appropriate segment duration which fits its current elevation angle. Moreover, the scheme of implicit indication enables the second device to determine the segment duration used by the first device before the transmission has been fully received and decoded.

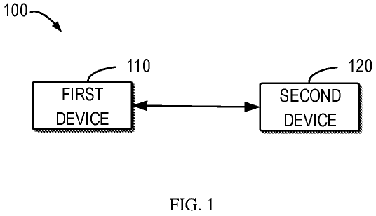

FIG. 1 shows an example environment 100 in which example embodiments of the present disclosure can be implemented.

The environment 100, which may be a part of a communication network, comprises two devices 110 and 120 communicating with each other or with other devices via each other. For the purpose of discussion, the devices 110 and 120 may be referred to as a first device 110 and a second device 120, respectively.

The first and second devices 110 and 120 may be implemented by any suitable devices in the communication network. In some example embodiments, the first device 110 may be implemented by a terminal device and the second device 120 may be implemented by a network device, or vice versa. In some other example embodiments, the first and second devices 110 and 120 may be both implemented by terminal devices or network devices. Just for the purpose of discussion, in this example, the terminal device will be taken as an example of the first device 110, and the network device will be taken as an example of the second device 120.

It is to be understood that two devices are shown in the environment 100 only for the purpose of illustration, without suggesting any limitation to the scope of the present disclosure. In some example embodiments, the environment 100 may comprise a further device to communicate with the first device 110 and the second device 120.

In some example embodiments, the first device 110 may be implemented by a user equipment and the second device 120 may be implemented by a base station, which can be either on a satellite or on the earth, connecting through a gateway to the satellite. The first device 110 communicates with the second device 120 via a satellite link.

The communications in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (eMBB), massive machine type communication (mMTC), ultra-reliable low latency communication (URLLC), Carrier Aggregation (CA), Dual Connection (DC), and New Radio Unlicensed (NR-U) technologies.

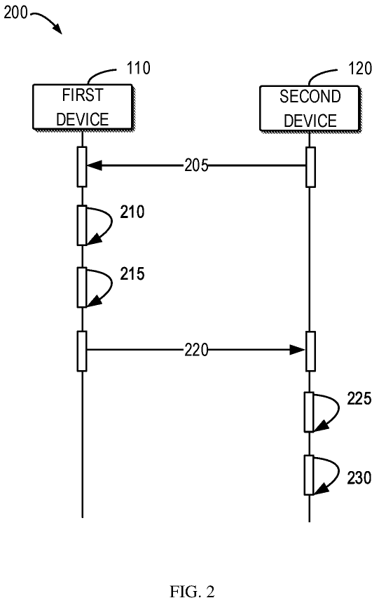

FIG. 2 shows a signaling flow 200 between the first device 110 and the second device 120 according to some example embodiments of the present disclosure. For the purpose of discussion, the signaling flow 200 will be described with reference to FIG. 1.

As shown in FIG. 2, the second device 120 sends (205), to the first device 110, a configuration of a plurality of segment durations for transmission from the first device 110 to the second device 120. In some example embodiments, the configuration of the plurality of segment durations may be sent in a system information broadcast. Alternatively, the configuration of the plurality of segment durations may be sent in a radio resource control signaling. For example, the configuration of the plurality of segment durations at least comprises the plurality of segment durations available to the transmission and mappings between the plurality of segment durations and transmission schemes usable for the transmission. Alternatively, the mappings between the plurality of segment durations and transmission schemes usable may be hard coded in the first device 110, without transmission of the configuration of the mappings from the second device 120 to the first device 110.

Accordingly, the first device 110 receives, from the second device 120, the configuration of the plurality of segment durations for the transmission. Then, the first device 110 determines (210) a segment duration of the plurality of segment durations. Some examples of the above step 210 are described below.

In some example embodiments, the first device 110 may determine a time drift during the transmission. For example, the device 110 may determine the time drift during the expected transmission time based on a location of the first device 110 and a location of the satellite. As an example, the location of the first device 110 may be determined based on global navigation satellite systems (GNSS) equipped on the first device 110 and the location of the satellite may be determined based on the ephemeris provided in the SIB. Then, in some example embodiments, the segment duration of the plurality of segment durations may be determined based on the time drift. For example, the segment duration of the plurality of segment durations may be determined on the basis that the time drift is within a limit in order to ensure that the time drift doesn't exceed transmission requirements for example as specified in the 3GPP specifications.

In some example embodiments, the segment duration of the plurality of segment durations may be determined based on an elevation angle between the first device 110 and a satellite. For example, the second device 120 may be on the satellite or on the earth. In this case, for example, the first device 110 may select a long segment duration from the plurality of segment durations, if the elevation angle between the first device 110 and the satellite is large. Accordingly, the first device 110 may select a short segment duration from the plurality of segment durations, if the elevation angle between the first device 110 and the satellite is small.

Referring back to FIG. 2, after the step 210, the first device 110 determines (215) a transmission scheme based on the determined segment duration.

In some example embodiments, the transmission scheme may be associated with a location of a first subcarrier to be used for the transmission. In this case, for example, the first device 110 may select Ninit, which is a parameter that defines the first subcarrier to be used for frequency hopping during the preamble transmission. Then, the remainder of the frequency hopping pattern may be determined based on this parameter. The hopping takes place after transmission of each symbol group (TCP+TSEQ).

For example, in some example embodiments related to NPRACH transmission, the mappings between a segment duration of the plurality of segment durations and the location of the first subcarrier to be used for the transmission may be determined based on the number of possible segment durations, for example, given in SIB (X). For example, if X=2, the mapping may be split evenly in two parts. As an example, if the location of the first subcarrier is transmitted in subcarriers 0-23, transmission with subcarriers 0-11 may indicate the use of segment duration 1, while transmission with subcarriers 12-23 may indicate the use of segment duration 2. Alternatively, the transmission starting in an even numbered subcarrier may indicate the use of segment duration 1, while the transmission starting in an odd numbered subcarrier may indicate the use of segment duration 2. Alternatively, a modulo operation X may be used to determine the mappings between a segment duration of the plurality of segment durations and the location of the first subcarrier to be used for the transmission.

Alternatively, the mappings may be split unevenly. For example, if X is large, this could result in more contention issues, such as preamble collisions, because UEs using the same segment duration are more likely to select the same preamble. In this case, for example, if the first device 110 selects segment duration 1, it may select any subcarrier for the transmission. Accordingly, if the first device 110 selects segment duration 2, it may select odd numbered subcarrier for the transmission.

As another example, the second device 120 may configure more than one segment duration based on the coverage area of the cell. If a cell contains UEs at both high and low elevation angles, the mappings may be split depending on the expected user distribution in the cell. For example, if there are more people in villages with an elevation angle and few people in other areas with another elevation angle, transmission with subcarriers 0-8 may indicate the use of segment duration 1, while transmission with subcarriers 9-23 may indicate the use of segment duration 2.

In some example embodiments, the transmission scheme may be associated with a transmission occasion to be used for the transmission. In this case, the first device 110 may select different transmission occasions, if it uses different segment durations. For example, a set of transmission occasions may indicate the use of segment duration 1, while another set of transmission occasions may indicate the use of segment duration 2. For example, the mapping may be divided evenly or unevenly, depending on implements of the second device 120.

In some example embodiments, the transmission scheme may be associated with a sequence indication of a preamble or a sequence indication of a reference signal to be used for the transmission. The sequence indication may be used to differentiate the sequences. For example, the sequence indication may be an index or an identity (ID) for a preamble or a reference signal to be used for the transmission, etc. In this case, the first device 110 may select different sequence indication, if it uses different segment durations. For example, a set of sequence indication may indicate the use of segment duration 1, while another set of sequence indication may indicate the use of segment duration 2. For example, the mapping may be divided evenly or unevenly, depending on implements of the second device 120.

In some example embodiments, the first device 110 may have highly accurate location knowledge, for example, if the first device 110 is mounted on a known position. In these example embodiments, the transmission scheme may be associated with a timing offset to reference timing or a frequency offset to a reference frequency of at least one transmission repetition of a segment to be used for the transmission. For example, the first device 110 may perform the implicit indication of the selection of the segment duration by controlling the time of reception at the second device 120. As an example, the implicit indication may be based on minor error of the time and/or frequency synchronization. In this case, if the first device 110 has accurate location knowledge, it may offset the transmission on purpose. For example, if the transmission arrives T-before the allocated time of the resource to be transmitted, it may indicate the use of segment duration 1. Likewise, if the transmission arrives T+ after the allocated time of the resource to be transmitted, it may indicate the use of segment duration 2. Similarly, if the transmission is shifted to be at a frequency offset F+ and F− compared to the allocated frequency of the resource to be transmitted, it may indicate uses of segment duration 1 and 2, respectively. For example, each of T−, T+, F−, F+ may be defined as a range. For example, T− may correspond to [−20:−10] microseconds, while T+ may correspond to [10:20] microseconds.

In some example embodiments, the transmission scheme may be associated with a combination of the above parameters related to the selection of the segment duration.

Then, the first device 110 performs (220) transmission to the second device 120 using the determined transmission scheme and the determined segment duration.

As shown in FIG. 2, the second device 120 determines (225) a transmission scheme used by the first device 110 for the transmission. As stated above, the transmission scheme may be associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

Then, the second device 120 determines (230) determines a segment duration for the transmission based on the transmission scheme. The segment duration is one of the plurality of segment durations configured by the second device 120. Based on the mappings between the plurality of segment durations and transmission schemes, the second device 120 may determine the segment duration used by the first device 110 for the transmission. The mappings between the plurality of segment durations and transmission schemes have been discussed in details above, for the purpose of simplification, the details will be omitted. Then, the second device 120 may utilize the determined segment duration to receive the transmission from the first device 110.

In some example embodiments, the second device 120 may order the first device 110 to perform random access through the PDCCH. In this case, the downlink control information (DCI) of the PDCCH may carry the configuration of the plurality of segment durations for the transmission. For example, the configuration may comprise the indication of what segment duration the first device 110 must apply. As another example, the configuration may comprise transmission resources for the random access.

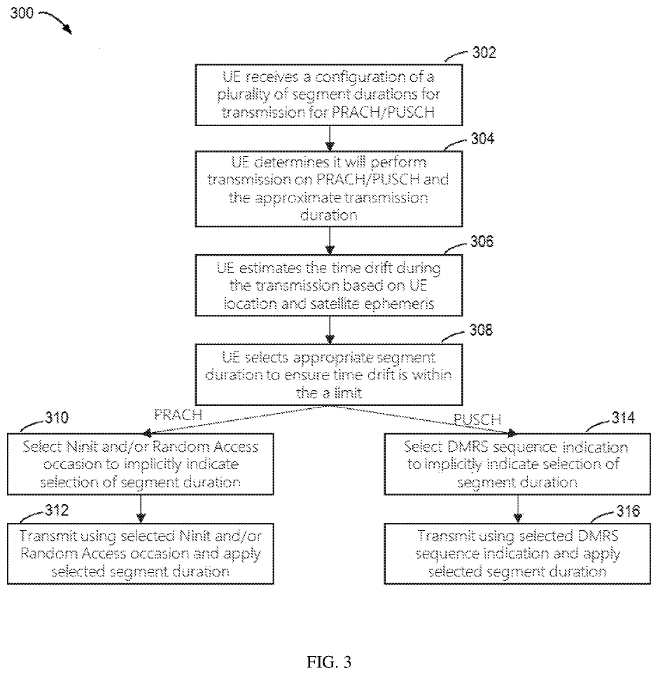

FIG. 3 illustrates an example process 300 at the first device 110 according to some example embodiments of the present disclosure. For the purpose of discussion, the process 300 will be described with reference to FIG. 1. For example, the first device 110 may be implemented by a UE.

As shown in FIG. 3, at 302, the UE receives a configuration of a plurality of segment durations for transmission on PRACH/PUSCH. For example, the configuration of the plurality of segment durations may at least comprise the plurality of segment durations available to the transmission and mappings between the plurality of segment durations and transmission schemes usable for the transmission. At 304, the UE determines it will perform transmission on PRACH/PUSCH and the approximate transmission duration.

Then, at 306, the UE estimates the time drift during the transmission based on UE location and satellite ephemeris. At 308, the UE selects appropriate segment duration to ensure time drift is within a limit for the transmission, in order to ensure that the time drift doesn't exceed transmission requirements.

In some example embodiments, if the UE determines it will perform transmission on PRACH, at 310, it selects the Ninit and/or the random access occasion to implicitly indicate the selection of the segment duration. Then, at 312, the UE transmits using the selected Ninit and/or random access occasion and apply selected segment duration.

In some other example embodiments, if the UE determines it will perform transmission on PUSCH, at 314, it selects demodulation reference signal (DMRS) sequence indication to implicitly indicate the selection of segment duration. Then, at 316, the UE transmits using selected DMRS sequence indication and apply selected segment duration.

All operations and features as described above with reference to FIGS. 1-2 are likewise applicable to the process 300 and have similar effects. For the purpose of simplification, the details will be omitted.

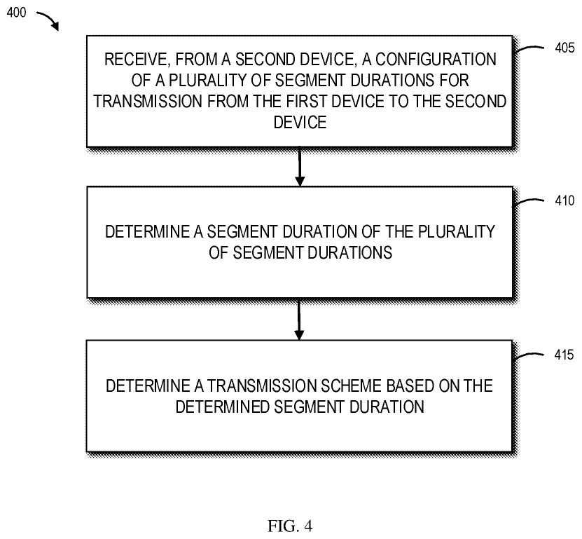

FIG. 4 shows a flowchart of an example method 400 according to some example embodiments of the present disclosure. The method 400 can be implemented at the first device 110 as shown in FIG. 1. For the purpose of discussion, the method 400 will be described with reference to FIG. 1.

At block 405, the first device 110 receives, from the second device 120, a configuration of a plurality of segment durations for transmission from the first device 110 to the second device 120. At block 410, the first device 110 determines a segment duration of the plurality of segment durations. At block 415, the first device 110 determines a transmission scheme based on the determined segment duration.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the first device 110 may further determine a time drift during the transmission. The segment duration of the plurality of segment durations may be determined based on the time drift.

In some example embodiments, the segment duration of the plurality of segment durations is determined based on an elevation angle between the first device 110 and a satellite.

In some example embodiments, the configuration of the plurality of segment durations at least comprises the plurality of segment durations available to the transmission and mappings between the plurality of segment durations and transmission schemes.

In some example embodiments, the transmission scheme is determined based on the determined segment duration and the mappings between the plurality of segment durations and transmission schemes.

In some example embodiments, the configuration of the plurality of segment durations is received in a system information broadcast or a radio resource control signaling.

In some example embodiments, the first device 110 is a terminal device and the second device 120 is a network device.

Those skilled in the art can understand that all operations and features as described above with reference to FIGS. 1-3 are likewise applicable to the method 400 and have similar effects.

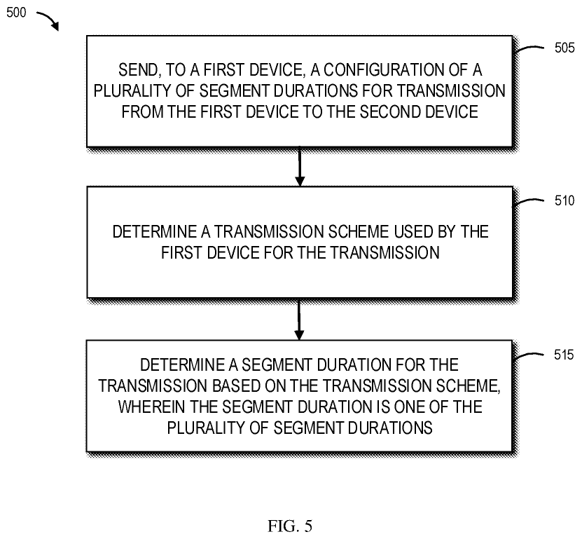

FIG. 5 shows a flowchart of an example method 500 according to some other example embodiments of the present disclosure. The method 500 can be implemented at the second device 120 as shown in FIG. 1. For the purpose of discussion, the method 500 will be described with reference to FIG. 1.

At block 505, the second device 120 sends, to a first device 110, a configuration of a plurality of segment durations for transmission from the first device 110 to the second device 120. At block 510, the second device 120 determines a transmission scheme used by the first device 110 for the transmission. At block 515, the second device 120 determines a segment duration for the transmission based on the transmission scheme, wherein the segment duration is one of the plurality of segment durations.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the configuration of the plurality of segment durations at least comprises the plurality of segment durations available to the transmission and mappings between the plurality of segment durations and transmission schemes.

In some example embodiments, the configuration of the plurality of segment durations is sent in a system information broadcast or a radio resource control signaling.

In some example embodiments, the first device 110 is a terminal device and the second device 120 is a network device.

Those skilled in the art can understand that all operations and features as described above with reference to FIGS. 1-4 are likewise applicable to the method 500 and have similar effects.

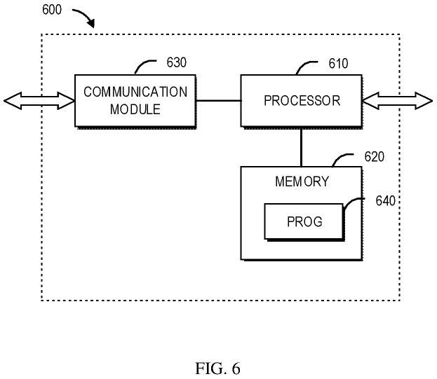

FIG. 6 is a simplified block diagram of a device 600 that is suitable for implementing example embodiments of the present disclosure. The device 600 can be implemented at or as a part of the first device 110 or the second device 120 as shown in FIG. 1.

As shown, the device 600 includes a processor 610, a memory 620 coupled to the processor 610, a communication module 630 coupled to the processor 610, and a communication interface (not shown) coupled to the communication module 630. The memory 620 stores at least a program 640. The communication module 630 is for bidirectional communications, for example, via multiple antennas. The communication interface may represent any interface that is necessary for communication.

The program 640 is assumed to include program instructions that, when executed by the associated processor 610, enable the device 600 to operate in accordance with the example embodiments of the present disclosure, as discussed herein with reference to FIGS. 1-5. The example embodiments herein may be implemented by computer software executable by the processor 610 of the device 600, or by hardware, or by a combination of software and hardware. The processor 610 may be configured to implement various example embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600. The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

When the device 600 acts as the first device 110 or a part of the first device 110, the processor 610 and the communication module 630 may cooperate to implement the method 400 as described above with reference to FIG. 1. When the device 600 acts as the second device 120 or a part of the second device 120, the processor 610 and the communication module 630 may cooperate to implement the method 500 as described above with reference to FIG. 1. All operations and features as described above with reference to FIGS. 1-5 are likewise applicable to the device 600 and have similar effects. For the purpose of simplification, the details will be omitted.

Generally, various example embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of example embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIG. 1. Generally, program modules include routines, programs, libraries, objects, classes, components, data structures, or the like that perform particular tasks or implement particular abstract data types. The functionality of the program modules may be combined or split between program modules as desired in various example embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable media.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), Digital Versatile Disc (DVD), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular example embodiments. Certain features that are described in the context of separate example embodiments may also be implemented in combination in a single embodiment. Conversely, various features that are described in the context of a single embodiment may also be implemented in multiple example embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Various example embodiments of the techniques have been described. In addition to or as an alternative to the above, the following examples are described. The features described in any of the following examples may be utilized with any of the other examples described herein.

In some aspects, a method comprises: at a first device, receiving, from a second device, a configuration of a plurality of segment durations for transmission from the first device to the second device; determining a segment duration of the plurality of segment durations; and determining a transmission scheme based on the determined segment duration.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the method further comprises: determining a time drift during the transmission, and wherein the segment duration of the plurality of segment durations is determined based on the time drift.

In some example embodiments, the segment duration of the plurality of segment durations is determined based on an elevation angle between the first device and a satellite.

In some example embodiments, the configuration of the plurality of segment durations at least comprises the plurality of segment durations available to the transmission and mappings between the plurality of segment durations and transmission schemes.

In some example embodiments, the transmission scheme is determined based on the determined segment duration and the mappings between the plurality of segment durations and transmission schemes

In some example embodiments, the configuration of the plurality of segment durations is received in a system information broadcast or a radio resource control signaling.

In some example embodiments, the first device is a terminal device and the second device is a network device

In some aspects, a method comprises: at a second device, sending, to a first device, a configuration of a plurality of segment durations for transmission from the first device to the second device; determining a transmission scheme used by the first device for the transmission; and determining a segment duration for the transmission based on the transmission scheme, wherein the segment duration is one of the plurality of segment durations.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the configuration of the plurality of segment durations at least comprises the plurality of segment durations available to the transmission and mappings between the plurality of segment durations and transmission schemes.

In some example embodiments, the configuration of the plurality of segment durations is sent in a system information broadcast or a radio resource control signaling.

In some example embodiments, the first device is a terminal device and the second device is a network device

In some aspects, a first device, comprises: at least one processor; and at least one memory including computer program code; the at least one memory and the computer program code configured to, with the at least one processor, cause the first device to: receive, from a second device, a configuration of a plurality of segment durations for transmission from the first device to the second device; determine a segment duration of the plurality of segment durations; and determine a transmission scheme based on the determined segment duration.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the first device is further caused to determine a time drift during the transmission, and wherein the segment duration of the plurality of segment durations is determined based on the time drift.

In some example embodiments, the segment duration of the plurality of segment durations is determined based on an elevation angle between the first device and a satellite.

In some example embodiments, the configuration of the plurality of segment durations at least comprises the plurality of segment durations available to the transmission and mappings between the plurality of segment durations and transmission schemes.

In some example embodiments, the transmission scheme is determined based on the determined segment duration and the mappings between the plurality of segment durations and transmission schemes.

In some example embodiments, the configuration of the plurality of segment durations is received in a system information broadcast or a radio resource control signaling.

In some example embodiments, wherein the first device is a terminal device and the second device is a network device.

In some aspects, a second device, comprises: at least one processor; and at least one memory including computer program code; the at least one memory and the computer program code configured to, with the at least one processor, cause the second device to: send, to a first device, a configuration of a plurality of segment durations for transmission from the first device to the second device; determine a transmission scheme used by the first device for the transmission; and determine a segment duration for the transmission based on the transmission scheme, wherein the segment duration is one of the plurality of segment durations.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the configuration of the plurality of segment durations at least comprises the plurality of segment durations available to the transmission and mappings between the plurality of segment durations and transmission schemes.

In some example embodiments, the configuration of the plurality of segment durations is sent in a system information broadcast or a radio resource control signaling.

In some example embodiments, the first device is a terminal device and the second device is a network device.

In some aspects, an apparatus comprises: means for receiving, from a second device, a configuration of a plurality of segment durations for transmission from the first device to the second device; means for determining a segment duration of the plurality of segment durations; and means for determining a transmission scheme based on the determined segment duration.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the apparatus further comprises: means for determining a time drift during the transmission, and wherein the segment duration of the plurality of segment durations is determined based on the time drift.

In some example embodiments, the segment duration of the plurality of segment durations is determined based on an elevation angle between the first device and a satellite.

In some example embodiments, the configuration of the plurality of segment durations at least comprises the plurality of segment durations available to the transmission and mappings between the plurality of segment durations and transmission schemes.

In some example embodiments, the transmission scheme is determined based on the determined segment duration and the mappings between the plurality of segment durations and transmission schemes

In some example embodiments, the configuration of the plurality of segment durations is received in a system information broadcast or a radio resource control signaling.

In some example embodiments, the first device is a terminal device and the second device is a network device

In some aspects, an apparatus comprises: means for sending, to a first device, a configuration of a plurality of segment durations for transmission from the first device to the second device; determining a transmission scheme used by the first device for the transmission; and determining a segment duration for the transmission based on the transmission scheme, wherein the segment duration is one of the plurality of segment durations.

In some example embodiments, the transmission scheme is associated with at least one of below parameters to be used for the transmission: a location of a first subcarrier; a transmission occasion; a sequence indication of a preamble; a sequence indication of a reference signal; or a timing offset to reference timing or a frequency offset to a reference frequency of at least one transmission repetition of a segment.

In some example embodiments, the configuration of the plurality of segment durations at least comprises the plurality of segment durations available to the transmission and mappings between the plurality of segment durations and transmission schemes.

In some example embodiments, the configuration of the plurality of segment durations is sent in a system information broadcast or a radio resource control signaling.

In some example embodiments, the first device is a terminal device and the second device is a network device

In some aspects, a computer readable storage medium comprises program instructions stored thereon, the instructions, when executed by a processor of a device, causing the device to perform the method according to some example embodiments of the present disclosure.

1-30. (canceled)

31. A first device, comprising:
at least one processor; and
at least one memory including computer program code;
the at least one memory and the computer program code configured to, with the at least one processor, cause the first device to:
receive, from a second device, a configuration of a plurality of segment durations for transmission from the first device to the second device;
determine a segment duration of the plurality of segment durations; and
determine a transmission scheme based on the determined segment duration.

32. The first device of claim 31, wherein the transmission scheme is associated with at least one of below parameters to be used for the transmission:
a location of a first subcarrier;
a transmission occasion;
a sequence indication of a preamble;
a sequence indication of a reference signal; or
a timing offset to reference timing or a frequency offset to a reference frequency of at least one transmission repetition of a segment.

33. The first device of claim 31, wherein the first device is further caused to determine a time drift during the transmission, and
wherein the segment duration of the plurality of segment durations is determined based on the time drift.

34. The first device of claim 31, wherein the segment duration of the plurality of segment durations is determined based on an elevation angle between the first device and a satellite.

35. The first device of claim 31, wherein the configuration of the plurality of segment durations at least comprises the plurality of segment durations available to the transmission and mappings between the plurality of segment durations and transmission schemes.

36. The first device of claim 35, wherein the transmission scheme is determined based on the determined segment duration and the mappings between the plurality of segment durations and transmission schemes.

37. The first device of claim 31, wherein the configuration of the plurality of segment durations is received in a system information broadcast or a radio resource control signaling.

38. The first device of claim 31, wherein the first device is a terminal device and the second device is a network device.

39. A second device, comprising:
at least one processor; and
at least one memory including computer program code;
the at least one memory and the computer program code configured to, with the at least one processor, cause the second device to:
send, to a first device, a configuration of a plurality of segment durations for transmission from the first device to the second device;
determine a transmission scheme used by the first device for the transmission; and
determine a segment duration for the transmission based on the transmission scheme, wherein the segment duration is one of the plurality of segment durations.

40. The second device of claim 39, wherein the transmission scheme is associated with at least one of below parameters to be used for the transmission:
a location of a first subcarrier;
a transmission occasion;
a sequence indication of a preamble;
a sequence indication of a reference signal; or
a timing offset to reference timing or a frequency offset to a reference frequency of at least one transmission repetition of a segment.

41. The second device of claim 39, wherein the configuration of the plurality of segment durations at least comprises the plurality of segment durations available to the transmission and mappings between the plurality of segment durations and transmission schemes.

42. The second device of claim 39, wherein the configuration of the plurality of segment durations is sent in a system information broadcast or a radio resource control signaling.

43. The second device of claim 39, wherein the first device is a terminal device and the second device is a network device.

44. A method comprising:
at a first device,
receiving, from a second device, a configuration of a plurality of segment durations for transmission from the first device to the second device;
determining a segment duration of the plurality of segment durations; and
determining a transmission scheme based on the determined segment duration.

45. The method of claim 44, wherein the transmission scheme is associated with at
least one of below parameters to be used for the transmission:
a location of a first subcarrier;
a transmission occasion;
a sequence indication of a preamble;
a sequence indication of a reference signal; or
a timing offset to reference timing or a frequency offset to a reference frequency of at least one transmission repetition of a segment.

46. A method comprising:
at a second device,
sending, to a first device, a configuration of a plurality of segment durations for
transmission from the first device to the second device;
determining a transmission scheme used by the first device for the transmission; and
determining a segment duration for the transmission based on the transmission scheme,
wherein the segment duration is one of the plurality of segment durations.
